(19) United States
(12) Patent Application Publication
(10) Pub. No.: US 2021/0247062 A1
(43) Pub. Date: Aug. 12, 2021

(54) Illuminated Cascading Fire on Water Feature and Method for Gas Injection and Ignition

(71) Applicants: Michael James Di Domenico, Downingtown, PA (US); Anthony Joseph DiAntonio, Coatesville, PA (US); Edward Joseph Francis Dougherty, Kennett Square, PA (US); Jeffrey Lee Schaefer, East Fallowfield, PA (US); John Spencer Zebley, Landenberg, PA (US)

(72) Inventors: Michael James Di Domenico, Downingtown, PA (US); Anthony Joseph DiAntonio, Coatesville, PA (US); Edward Joseph Francis Dougherty, Kennett Square, PA (US); Jeffrey Lee Schaefer, East Fallowfield, PA (US); John Spencer Zebley, Landenberg, PA (US)

(21) Appl. No.: 16/784,313

(22) Filed: Feb. 7, 2020

(51) Int. Cl. F21V 33/00; F23N 1/00

(52) U.S. Cl. CPC F21V 33/0028; F21Y 2115/10; F23N 1/005

(57) ABSTRACT

Methods and designs for an illuminated cascading water feature with flammable gas injection and remote ignition for a fire burning on water effect. Designs can include a cylindrical water feature that optionally includes multi-color lighting, which illuminates the tank and contents of the tank in low light environments. Additionally, this illuminated tank has gas injected into it and if flammable, a remote system for igniting the flammable gas.

### BACKGROUND

### 1. Field of the Invention

The invention generally relates to a water-based feature or fountain of ornamental value that contains special effects, particularly the cascading appearance of the water on the feature, the flame on the top of the feature and the Light Emitting Diodes (LEDs) that color the water in the feature.

### 2. Background of the Invention

For centuries, mankind has used natural elements such as fire, water, and light in storytelling and entertainment scenarios by inventing various technologies to control and harness them. Fires can burn indoors in fireplaces or outdoors in fire pits. Water can be harnessed through movement to dazzle the eye or evoke a range of emotions. Light also has the same incredible power to cause audiences to feel a certain way through color or by drawing attention to an object.

Common knowledge and science tells us that when you combine any or all of these elements, one will extinguish the other. When you put water on fire, the flame and light disappear. Audiences looking to be entertained today have become increasingly desensitized to these individual centuries-old elements.

Features such as vortex fountains, cascading waterfalls, fire on top of water, and Light Emitting Diode (LED) illumination of water are not new concepts and have provided a unique experience for people throughout the world. These features can be found at hotels, concerts, offices, and many other locations where the designers are trying to make a unique statement.

Many products exist today where there is a gas burner on the surface of water that creates flame to produce the visual effect of fire on water. These can be backyard fire pits, cauldrons, or many other designs that provide this unique phenomenon.

In the same effect, walls that have water cascading over them have been created in many different variations. For example, these walls can be stone, plastic, or even glass. In some cases, they can even have lighting, like LEDs, to illuminate the wall and cascading water.

All three elements have been successfully combined here through the use of technology in a way that captivates the modern audience through a whole new kind of dynamic illumination.

### SUMMARY

In summary, this disclosure relates to a visual water feature that includes the effects of cascading water, multi-color illumination, gas injection, and remote ignition of flammable injected gases.

In the first aspect, the visual water feature is a cylindrical tank that includes several holes in the bottom for output, liquid input, and gas input. The top of this cylindrical tank is open so that water is intended to overflow at a rate greater than the gravitational pull through the center drain. This cylindrical tank is made out of a translucent plastic that is structurally capable of holding a liquid.

In a second aspect, the cylindrical tank includes a pump to fill the tank, with an input located in the bottom or sidewall of the tank. This pump can be used in conjunction with a plumbing elbow to direct the water in a circular fashion. In the same aspect, an output located in the center of the cylindrical tank can create a vortex effect.

In a third aspect, the cylindrical tank has the ability for water to flow over the top of the tank. This overflow gives the visual effect of cascading water. To get the cascading effect, utilizing the pump, more liquid has to be added into the cylindrical tank than what is lost either by an output in the bottom of the tank, or through the flow of water over the top of the tank.

In a fourth aspect, an input in the bottom, or side, of the tank can be used as a way to inject gas into the cylindrical tank and fluid to give it an effect of swirling bubbles. The hole in the bottom of the tank can be converted into a smaller hose to change the size, and position, of the bubbles in the tank. For example, the gas being injected could be air, oxygen, nitrogen, butane, or propane. This injection is done by pumping pressurized gas through hoses and into the cylindrical tank.

In a fifth aspect, this cylindrical tank could be illuminated. The illumination can be a solid single color, multiple colors, different levels of brightness, or any combination thereof. Illumination is done at the bottom of the tank, either on the inside, or outside of the tank to illuminate the translucent plastic bottom, sides, and tank contents.

In a sixth aspect, if the bubbles being injected into the cylindrical tank are flammable, a remote ignition system can be affixed to the tank. This remote ignition system uses a small ignition source that is capable of igniting the gas as it moves through the cylinder.

### BRIEF DESCRIPTIONS OF THE DRAWINGS

FIG. 1 is a design representation of the visual water feature.

FIG. 2 is an overall perspective view of the visual water feature.

FIG. 3A-3C are detailed diagrams of the basin component of the visual water feature.

FIG. 4 is a detailed diagram for the structure of the tank stand.

FIG. 5 is a detailed diagram of the cylindrical tank.

FIG. 6A-6C are detailed drawings of the gas dispersion mounts affixed to the cylindrical tank.

FIG. 7A-7C are detailed diagrams of gas manifold.

FIG. 8A-8B are detailed diagrams of the gas distribution manifold.

FIG. 9 is a schematic of the gas safety switch configuration.

FIG. 10 is a detailed diagram of the ignition control system.

FIG. 11A-11B are schematics of the ignition control system.

FIG. 12 is a detailed diagram of the lighting control system.

FIG. 13 is a schematic of the lighting control system.

FIG. 14 is a detailed diagram of the computer-based control system.

FIG. 15 is a block diagram of the entire visual water feature system.

### DETAILED DESCRIPTION

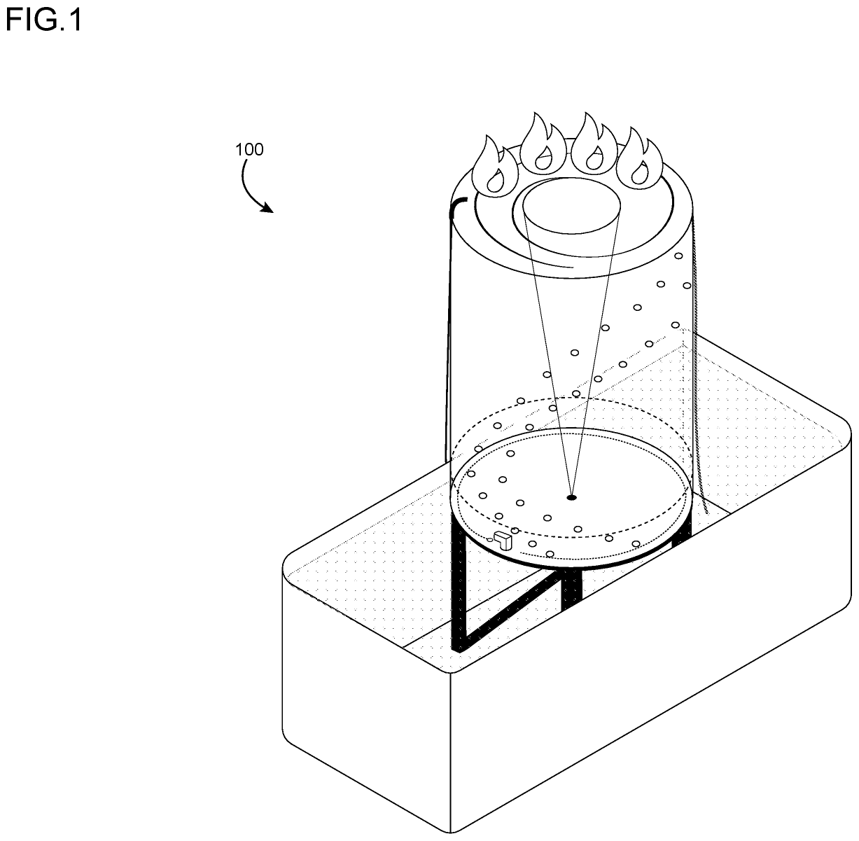

The features and methods described herein allow for a visual water feature to be configured in any combination of several ways based on the visual effects, like cascading water, multi-color illumination, gas injection, and remote ignition of flammable injected gas, similar to the one pictured in FIG. 1. The visual water feature could be controlled remotely by any combination of devices such as the Beefcake Relay Control Kit product by SparkFun Electronics® and software such as Nomad product by ETC®.

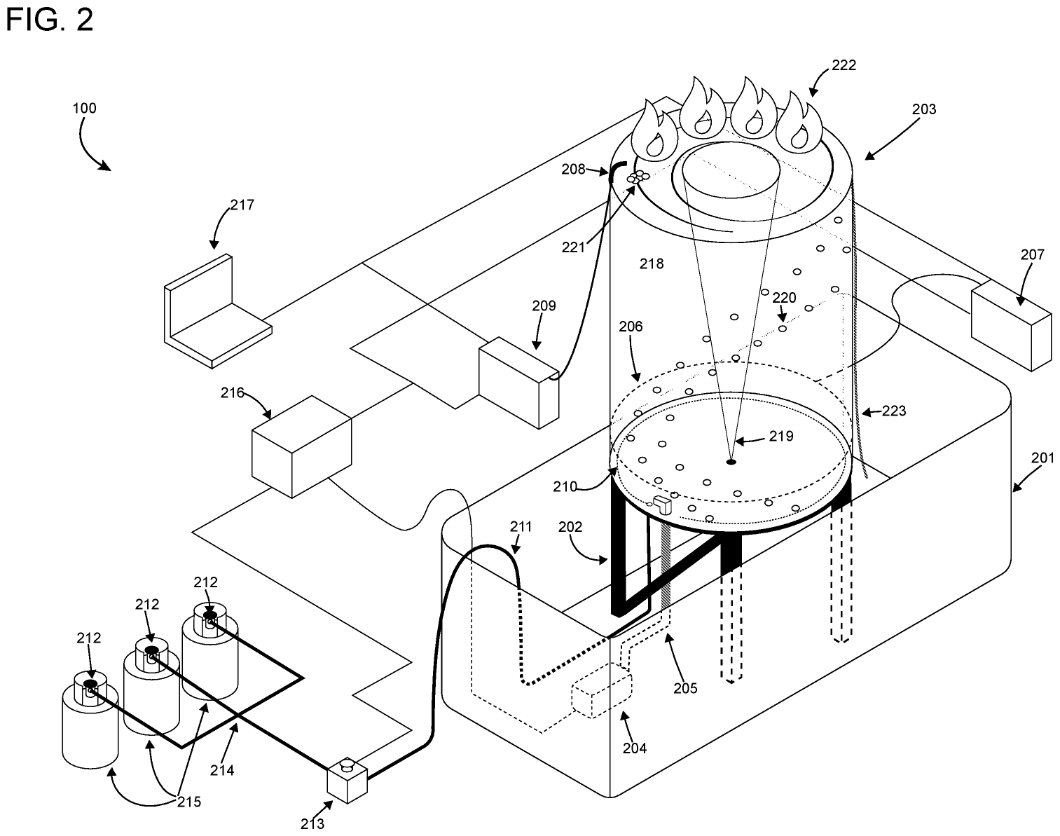

Now referring to FIG. 2, a perspective view of the visual water feature 100 in which effects of the present disclosure can be implemented is shown. As shown in the example, the visual water feature 100 includes basin 201, stand 202, cylindrical tank 203, liquid pump 204, plumbing 205, multi-color lighting 206, lighting control circuitry 207, igniter 208, ignition control circuitry 209, gas manifold 210, gas supply line 211, gas regulators 212, gas safety switch 213, gas distribution manifold 214, gas storage tanks 215, electrical power 216, computer-based control 217, liquid water 218, vortex 219, gas bubbles 220, flammable gas 221, flame 222, and liquid water cascade 223.

In the perspective shown, the basin 201 is a container capable of holding liquid for circulation through the visual water feature. This basin could be a trough, tank, or any object that is capable of holding liquid water 218. Sitting inside of basin 201 is a stand 202 that is built of wood, metal, or plastic with the capacity to support the weight of a cylindrical tank 203, multi-color lighting 206, igniter 208, ignition control circuitry 209, gas manifold 210, and liquid water 218 at an assumed weight of 8.34 pounds per gallon.

The cylindrical tank 203 is a container capable of holding liquid water made from materials like acrylic, plastic, or metal. Liquid pump 204 is designed to sit in or be connected to the basin 201 for circulating liquid water 218 through plumbing 205 and into the cylindrical tank 203. Affixed to the cylindrical tank 203 is multi-color lighting 206 with connections to lighting control circuitry 207 and igniter 208 with connections to ignition control circuitry 109. Lighting control circuitry 207 contains the electronic and software components for turning on, turning off, and changing colors of the multi-color lighting 206. Ignition control circuitry 209 contains the electronic components required to enable the ignition of flammable gases 221 and creation of flame 222.

Gas manifold 210 is affixed to the bottom of cylindrical tank 203 through the stand 202 and connected to gas supply line 211 through a connection in the base of cylindrical tank 203 and evenly distributes the gas provided from gas storage tanks 215 forming gas bubbles 220. Gas supply line 211 connects the gas storage tanks 215 and gas regulator 212 to the gas safety switch 213. The gas regulator 212 allows the amount of flammable gas 221 to be controlled and fine tuned. The gas safety switch 213 is connected to the gas manifold 210 through solid or flexible gas supply line 211. Gas supply line 211 connects the gas distribution manifold to gas manifold 210. Gas safety switch 213 contains a button and valves for turning the gas storage tanks 215 on or off, for example, in the event of an emergency. The gas distribution manifold 214 is connected to the gas safety switch 213 and connects gas storage tanks 215 together to provide the proper volume of flammable gas 221 in order to sustain flame 222.

The electrical power system 216 includes the alternating current (AC) and direct current (DC) power required to make all components work. Computer-based control system 217 is a programmable circuit designed to give a user the ability to control the lighting control circuitry 207, liquid pump 204, ignition control circuitry 209, and gas safety switch 213. Liquid water 218 is the medium that is circulated through the basin 201, pump 204, plumbing 205, and fills cylindrical tank 203. Liquid water 218 overflows the top of cylindrical tank 203, creating liquid water cascade 223, to be caught in basin 201. Gas bubbles 220 are created by flammable gas 221 and converted into the gas bubbles 220 by gas manifold 210 rising through liquid water 218. Flammable gas 221 is stored in gas storage tanks 215, runs through gas regulator 212, distribution manifold 214 and gas supply line 211, converted into the gas bubbles 220, and no longer contained by a medium like liquid water 218. Flame 222 is the flammable gas 221 that is ignited by igniter 208 to cause combustion of the flammable gas.

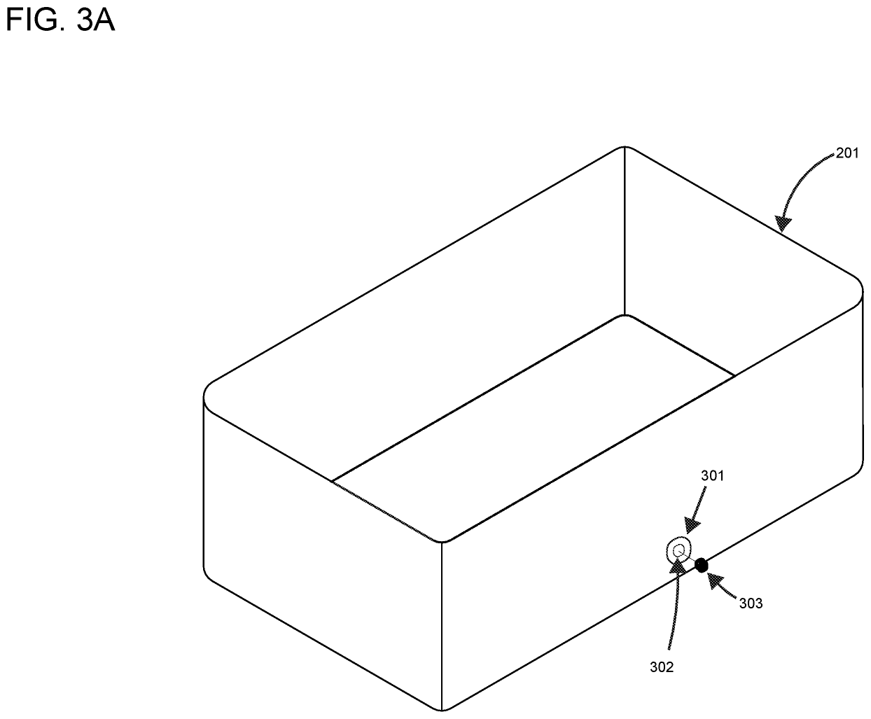

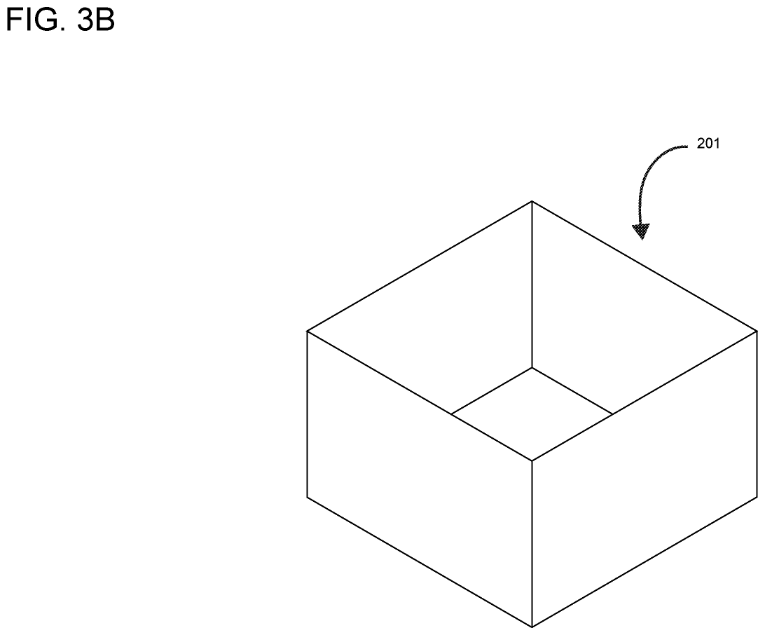

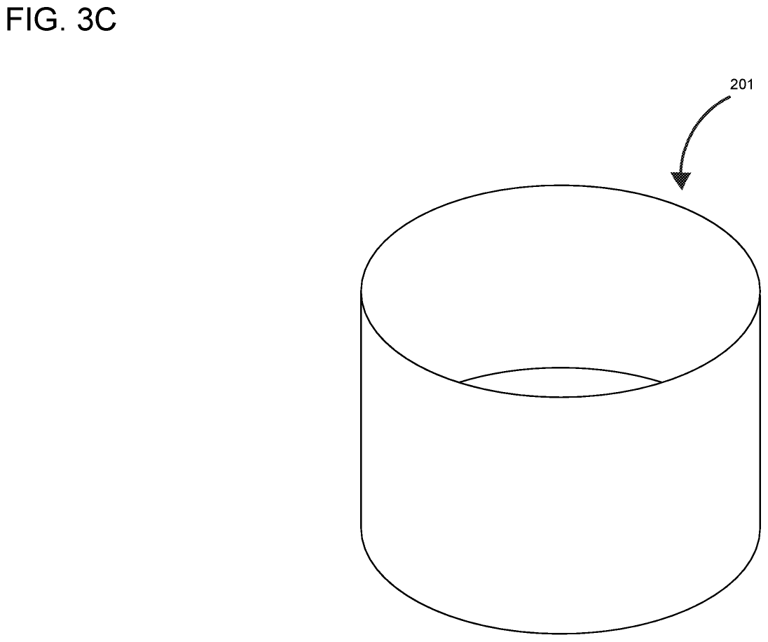

Now referring to FIG. 3A-C, a diagram of the basin for the visual water feature 100. The basin 201 is an object that is capable of containing liquid water 218 that results in creating a recirculation system for cylindrical tank 203. This basin can come in any size and shape, for example ovular as represented in FIG. 3A, square as represented in FIG. 3B, or round as represented in FIG. 3C. For the scope of this embodiment reference to basin 201 will be represented by FIG. 3A.

Basin 201 needs to be capable of holding liquid water 218 and for example the volume of that water can be calculated as

Wmin=Pmin+T+(Wloss*H)

Where
Wmin is the minimum volume of the basin has to hold.
Pmin is the minimum volume of water required for the pump to operate.
T is the volume of the cylindrical tank 203.
Wloss is the water lost per hour during operation of the visual water feature 100.
H is the number of hours that the visual water feature 100 needs to run.

For example, if T is calculated to be 130 gallons, Pmin is calculated to be 10 gallons based on the minimum water height required and the size of the basin, Wloss is calculated as losing 1 gallon per hour of operation, and H is calculated as running for 10 hours, then basin 201 has to be a minimum size of 150 gallons.

Additionally, basin 201 can contain a drain 301. The drain 301 enables ease of draining liquid water 218 from the basin for service, moving, etc. and consists of drain hole 302 and drain plug 303. The drain hole 302 is part of basin 201 and can be threaded. Drain plug 303 is a water-tight plug that can be sandwiched in drain hole 302 or screwed into drain hole 302. Alternatively, drain plug 303 could be a ball-valve or slicer-valve style plug and be permanently affixed to drain hole 302.

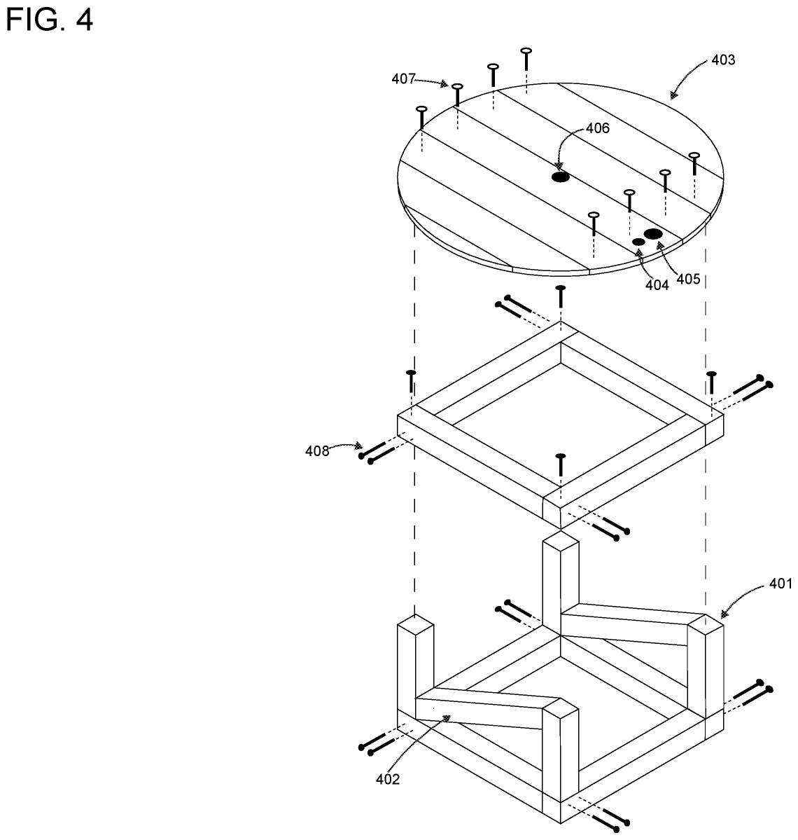

Now referring to FIG. 4, a detailed diagram for the structure of tank stand 202. Tank stand 202 contains supporting posts 401, cross supports 402, tank deck 403, gas supply cutout 404, liquid water supply cutout 405, vortex drain cutout 406, and mounting hardware 407 and 408.

Based on the size of the tank, stand 202 needs to be capable of holding a significant amount of weight. The material used to support the tank may be non pressure treated or pressure treated wood, metal, or plastic. For example, wooden material like square 3.5 inch by 3.5 inch posts known as 4×4 posts and 1.5 inch by 5.5 inch boards known as 2×6 boards could be used. In another embodiment, tank stand 202 may be built out of metal, like steel or aluminum.

The supporting posts 401 are the main objects, for example 4×4 posts which hold the weight of the tank 203 above the ground. These supporting posts can be as tall or as short as needed for the tank to be the height so that it sits on or above the water line determined by the size of the basin 201. Optionally, cross supports 402 are used to stabilize the tank 203 and stand 202 from shifting side to side either by movement of water, persons touching tank 203, or other means that could possibly make the tank tilt or fall. These cross supports, as shown in the diagram 402a being horizontal and 402b being diagonal.

The tank deck 403 is the surface that the tank 203 sits on and evenly distributes the weight of the tank itself across supporting posts 401. In an embodiment where the tank has the water and gas inputs on the bottom, holes in the tank deck 403 need to be made so that the plumbing can fit through the deck and attach to the tank. Additionally, tank deck 403 has a cutout 406 in the center so that the vortex can form and water drain out of the tank and back into basin 201 for recirculation.

In an embodiment where the water supply and gas supply are through the bottom of the tank 203 the cutouts 404 and 405 are made in the tank deck 403 so that the plumbing can be attached. In an embodiment where the tank is permanent, the piping through the cutouts 404 and 405 only need to be the size of the pipe. In an embodiment where the tank needs to be portable, the cutouts 404 and 405 need to be larger so that the plumbing can be easily connected and disconnected for setting up and disassembling the water feature. In this case, a threaded bulkhead fitting could be used to make the connections easier to work with and the cutouts need to be sized to fit the fitting through. Gas supply cutout 404 may be smaller in size than liquid water supply cutout 405.

In an embodiment where the tank stand 202 is made of wood, hardware 407 and 408 are used to assemble the different sized pieces together. For example, hardware 407 may be deck screws used to affix the 2×6 boards to the 4×4 cross supports and hardware 408 may be lag bolts used to affix 4×4 posts to 4×4 cross supports.

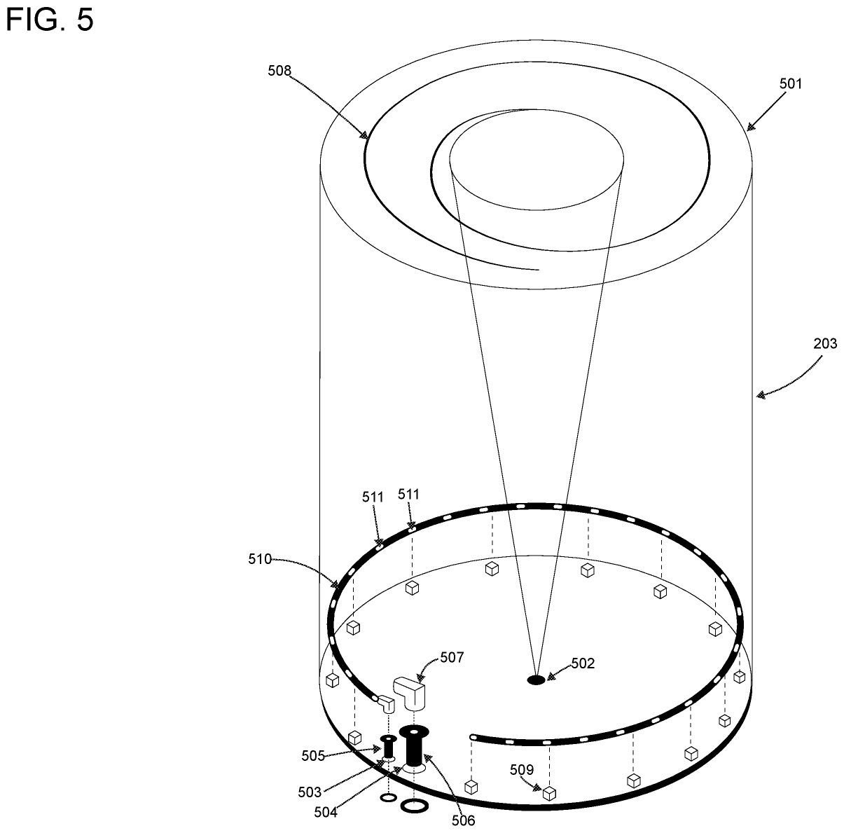

Now referring to FIG. 5, a detailed diagram of the cylindrical tank. Cylindrical tank 203 consists of opening 501 at the top, vortex hole 502 in the bottom center, gas inlet hole 503 and water inlet hole 504 on the bottom side with optional gas bulkhead fitting 505 and optional water bulkhead fitting 506 connecting through gas inlet hole 503 and water inlet hole 504, respectively. Directional water flow connector 507 connected to water bulkhead fitting 506 directs the water from the liquid pump 204 through the cylindrical tank 203 in a circular fashion as shown in 508. Gas manifold hose mounts 509 affixed to bottom of cylindrical tank 203. Gas manifold hose 510 is connected to optional gas bulkhead fitting 505 and contains gas outlets 511. Igniter 208 and ignition control circuitry 209 are affixed to the back side of the cylindrical tank 203 with adhesive 510. Multi-color lighting 206 is affixed to the bottom of the cylindrical tank 203.

In another embodiment, gas inlet hole 503 and water inlet hole 504 are positioned on the side of the cylindrical tank 203. In another embodiment, gas manifold hose mounts 509 are located on the side of the cylindrical tank 203.

Material used for construction of cylindrical tank 203 could be polyvinyl chloride (PVC), polycarbonate, polypropylene, or polymethyl methacrylate (acrylic) and contain any number of colors like black, white, red, or blue and have any level of transparency, translucency, and opaqueness. For the scope of this embodiment a fully transparent acrylic material is going to be used.

Cylindrical tank 203 could be constructed from a single piece of material or multiple pieces as shown in 203. The material for cylindrical tank 203 can be constructed from multiple pieces of material like acrylic and bonded together with an adhesive like glue or epoxy. For example, Weld-on #4 or Weld-on #40 by Weld-On Adhesives, Inc. could be used to bond the multiple acrylic pieces together.

In order to create the vortex 219 effect inside the cylindrical tank 203, vortex hole 502 is added to the bottom center of cylindrical tank 203. This, in combination with directional water flow connector 507, creates a funnel cavity in the center of the cylindrical tank 203 and in turn producing the effect of vortex 219.

If vortex hole 502 is coupled with flammable gas 221 then the size of vortex hole 502 must be smaller than the water inlet hole 504. The result of this is so that water can cascade over the rim of cylindrical tank 203, creating water cascade 223. When flammable gas 221 is ignited and becomes flame 222, in certain conditions the flame can cause the material of cylindrical tank 203, like acrylic, to be scorched or melted. Having liquid water 218 flow over the rim will prevent this from happening. Minimum height for water flowing over the rim is about 3 mm and dependent on the sizes of liquid pump 204, water inlet hole 504, and vortex hole 502.

In addition to directional water flow connector 507 producing the vortex effect, when gas bubbles 220 are created by gas manifold 210, and flammable gas 221 is ignited, the water flow connector 507 provides liquid water 218 movement in a circular direction that carries flammable gas 221 as it rises to the surface of the water at the top of cylindrical tank 203. This creates a mechanism that prevents large gas bubbles 220 of flammable gas 221 from forming.

Affixed to the side of cylindrical tank 203 is igniter 208 and optionally all or part of ignition control circuitry 209. Igniter 208 provides an electrical spark to ignite flammable gas 221 that is on the surface of liquid water 218 in cylindrical tank 203. The ignition of flammable gas 221 produces flame 222. The igniter is positioned above the surface of liquid water 218 far enough away that it does not get wet but close enough to ignite the flammable gas 221. Ideally, this is roughly from 1 cm to 2.5 cm above the surface. The igniter 208 and optionally all or part of ignition control circuitry 209 can be affixed to the side of the tank by means of a waterproof or water resistant adhesive. Adhesive 510 can be glue like Weld-on #40 by Weld-On Adhesives, Inc. or tape like Gorilla Tape by The Gorilla Glue Company.

Affixed to the bottom of cylindrical tank 203, or side of cylindrical tank 203, are gas manifold hose mounts 509. In the example of cylindrical tank 203 being made from acrylic, gas manifold hose mounts 509 are small pieces of acrylic affixed to and spaced every 15 cm around the entire bottom, or side, of cylindrical tank 203. Gas manifold hose mounts 509 could be affixed to cylindrical tank 203 with Weld-on #4 or Weld-on #40 by Weld-On Adhesives, Inc.

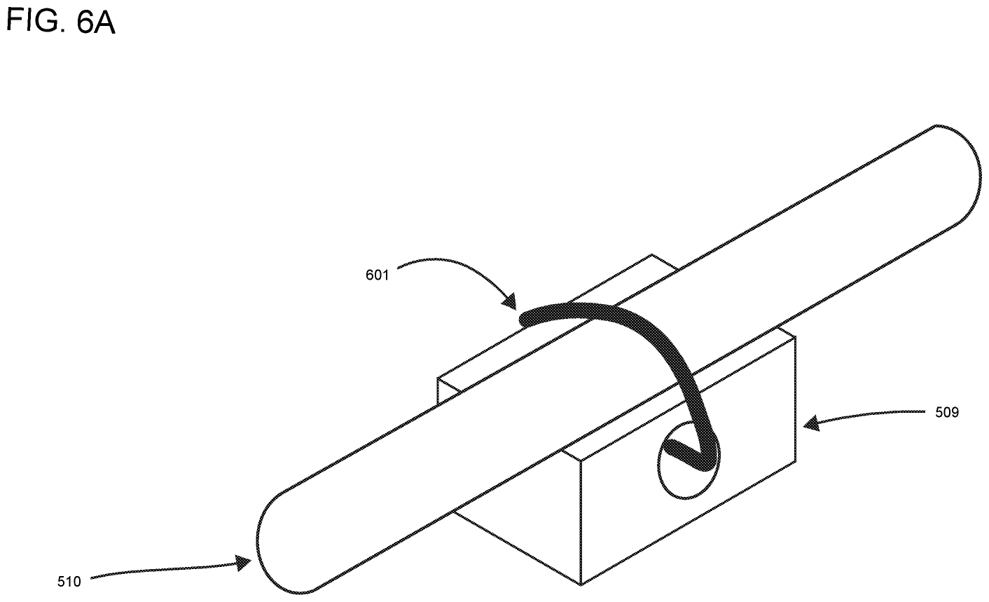

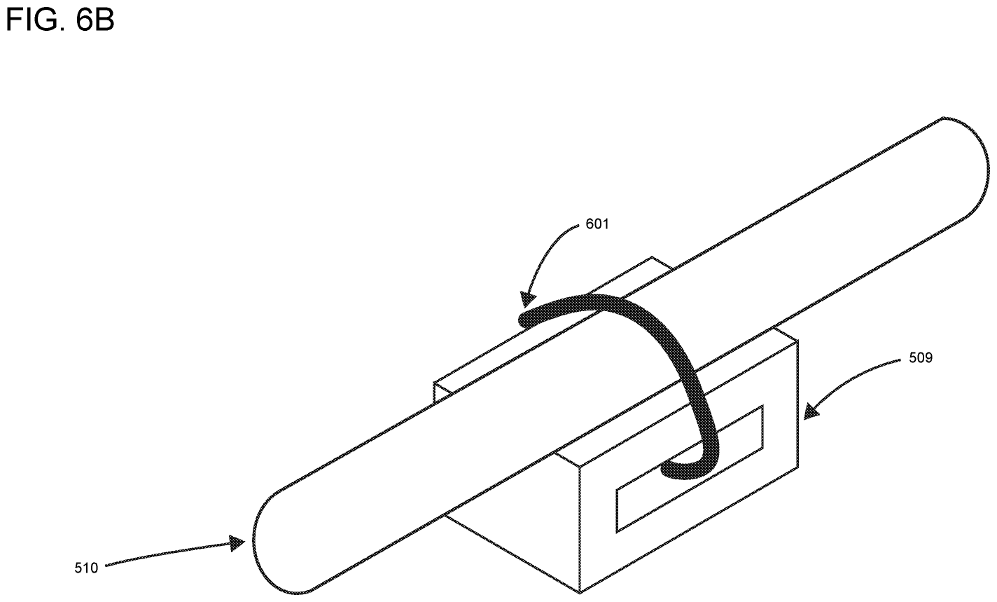

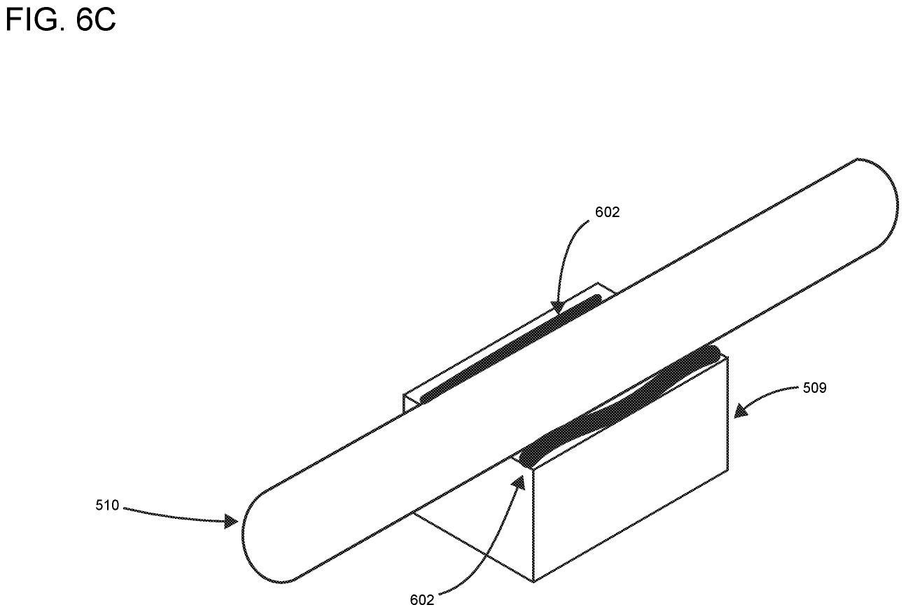

Gas manifold hose mounts 509 can be designed so that gas manifold 210 is permanently affixed to cylindrical tank 203 or temporarily attached to cylindrical tank 203. If service needs to be done to the gas manifold 210, then gas manifold 210 can be temporarily attached to gas manifold hose mounts 509 as shown in FIG. 6A and FIG. 6B. Ty-Rap by ABB Installation Products Inc. is an example of a product that can be used to attach gas manifold 210 to gas manifold hose mounts 509 as shown by 601. Alternatively, gas manifold 210 can be permanently affixed to gas manifold hose mounts 509 with glue like Weld-on #40 by Weld-On Adhesives, Inc. as shown in FIG. 6C.

Multi-color lighting 206 is made from a strip of red-green-blue (RGB) light-emitting diodes (LEDs) and can be affixed to the outside or inside of cylindrical tank 203. In the example of cylindrical tank 203 being made from acrylic, multi-color lighting 206 LEDs are pointing towards the acrylic. For example, if multi-color lighting 206 is affixed to the outside of cylindrical tank 203 then the LEDs are pointed towards cylindrical tank 203. They can be affixed to cylindrical tank 203 with glue like Weld-on #40 by Weld-On Adhesives, Inc. or tape like Gorilla Tape by The Gorilla Glue Company as shown by 602.

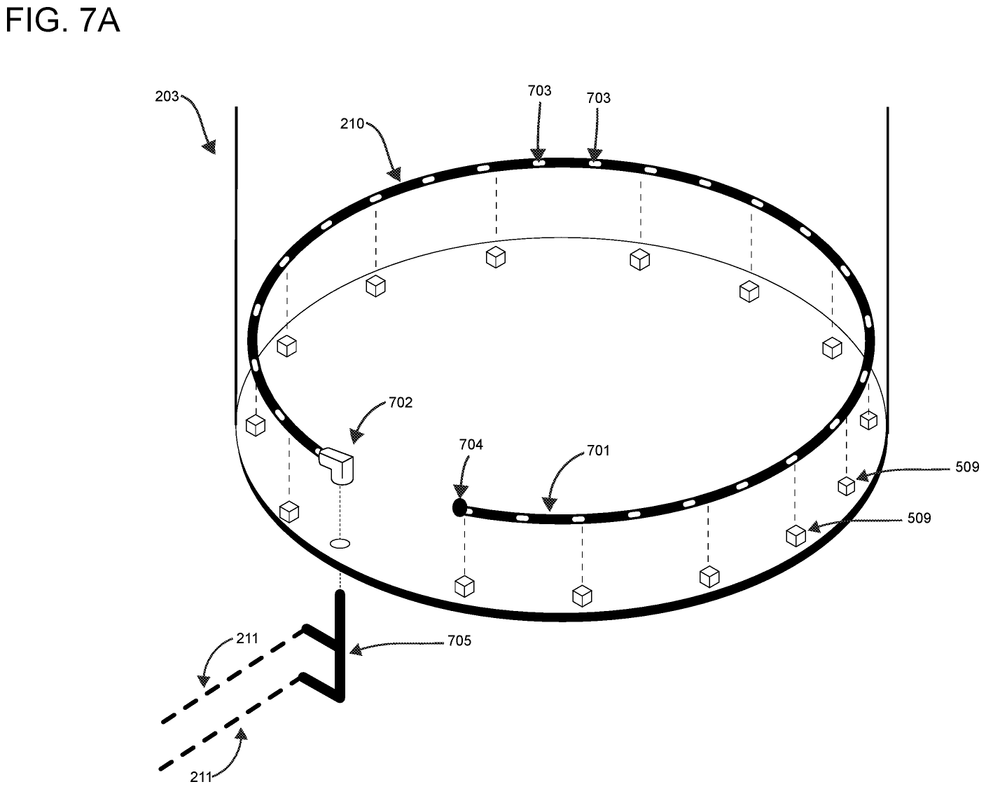

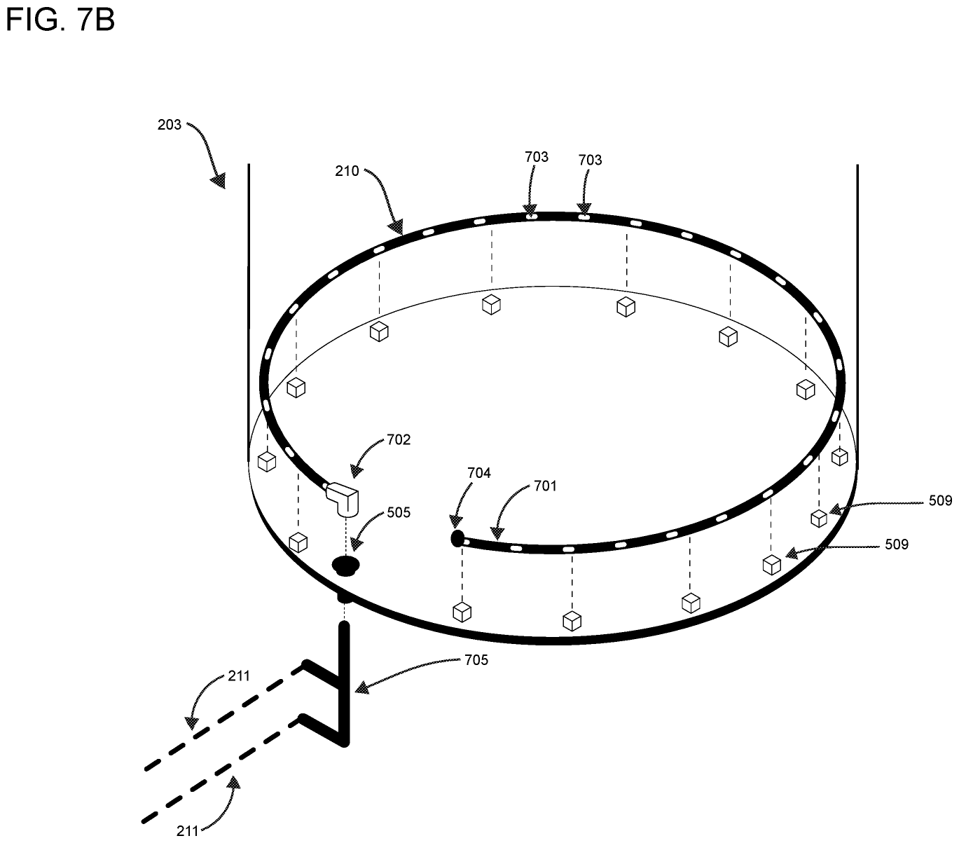

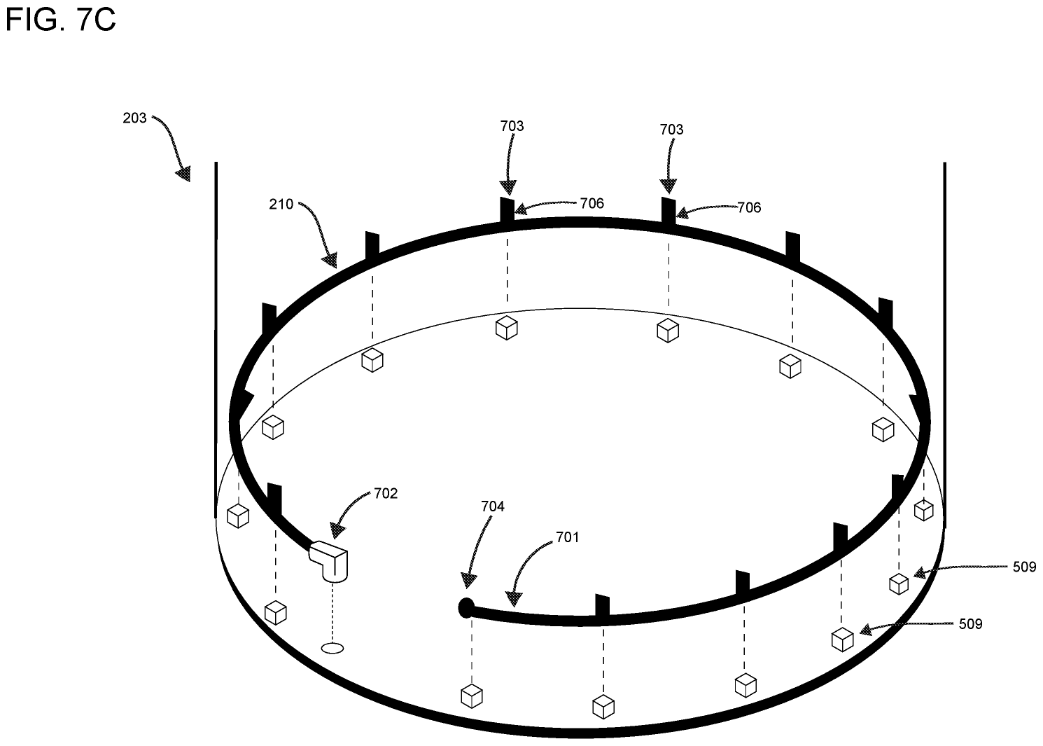

Now referring to FIG. 7A-C, a detailed diagram of gas manifold. Gas manifold 210 is the component that takes flammable gas 221 from gas supply line 211 and converts it into gas bubbles 220 inside of cylindrical tank 203. As shown in FIG. 7A, gas manifold 210 consists of several components, manifold tube 701, inlet connector 702, output orifices 703, and end cap 704. Gas manifold 210 is affixed to cylindrical tank by gas manifold hose mounts 509.

In some embodiments, gas distribution manifold 214 and gas supply line 211 are portable and require the gas supply line 211 to be removed for transport and storage. It is possible that plumbing with the required size to support the volume of flammable gas 221 required to sustain flame 222 is not available. In this case, it is possible for gas supply line 211 to consist of multiple hoses or pipes and are combined together at the gas manifold 210, as shown by the gas tee adapter 705.

Gas manifold tube 701 is a hollow tube made out of a material like copper, plastic, or metal. The tube connects to the inlet connector 702, end cap 704, and contains the output orifices 703. The size gas manifold tube 701 is dependent on the number and size of output orifices 703 and must have enough volume to hold the amount of flammable gas 221 being supplied by gas supply line 211. This tube is made into a circular shape and affixed to the bottom, or side, all the way around cylindrical tank 203 by gas manifold hose mounts 509.

Inlet connector 702 is a component that connects the gas supply line 211, or gas tee adapter 705 to the gas manifold. Inlet connector 702 also consists of the components that fit through the gas supply cutout 404 of the tank deck 403. Additionally, this can be done through gas bulkhead fitting 505 as shown in FIG. 7B.

Output orifices 703 are made in gas manifold 210 for the flammable gas 221 to be converted into gas bubbles 220 in liquid water 218. Depending on the material gas manifold tube 701 is made out of, they can be as simple as a hole in a material like copper pipe, as shown in FIG. 7B, or they can be holes on top of nozzles 706 that are mounted on a material like copper pipe, as shown in FIG. 7C.

End cap 704 is used to cap off gas manifold tube 701 so that all flammable gases 221 exit through the output orifices 702. The end cap can be affixed to gas manifold tube 701 by means of glue, solder, or other air-tight material depending on the composition of gas manifold tube 701.

In order to determine how much flammable gas 221 is required to be supplied to gas manifold 210 a basic formula of

Vg=(O*Xo)*1.2

Where
Vg is the volume of gas required.
O is the number of output orifices 702 in the gas manifold
Xo is the size of the output orifices 702 in the gas manifold
1.2 is a factor to enable pressure of flammable gas 221 in gas manifold tube 701

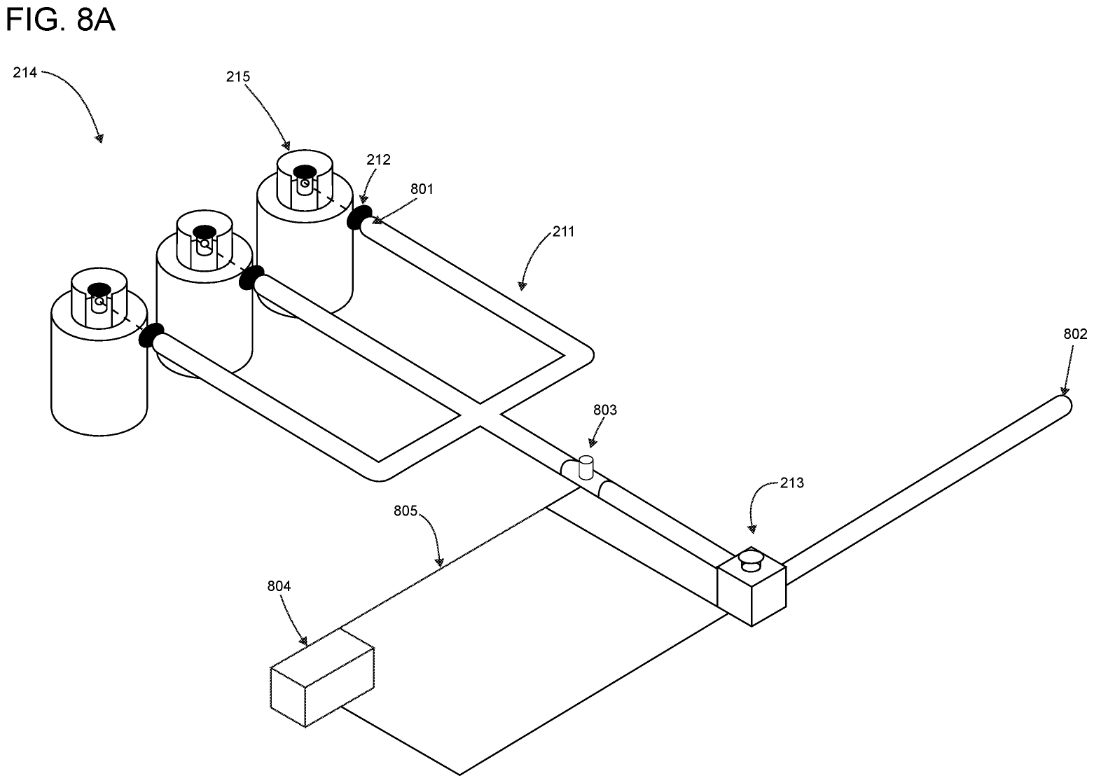

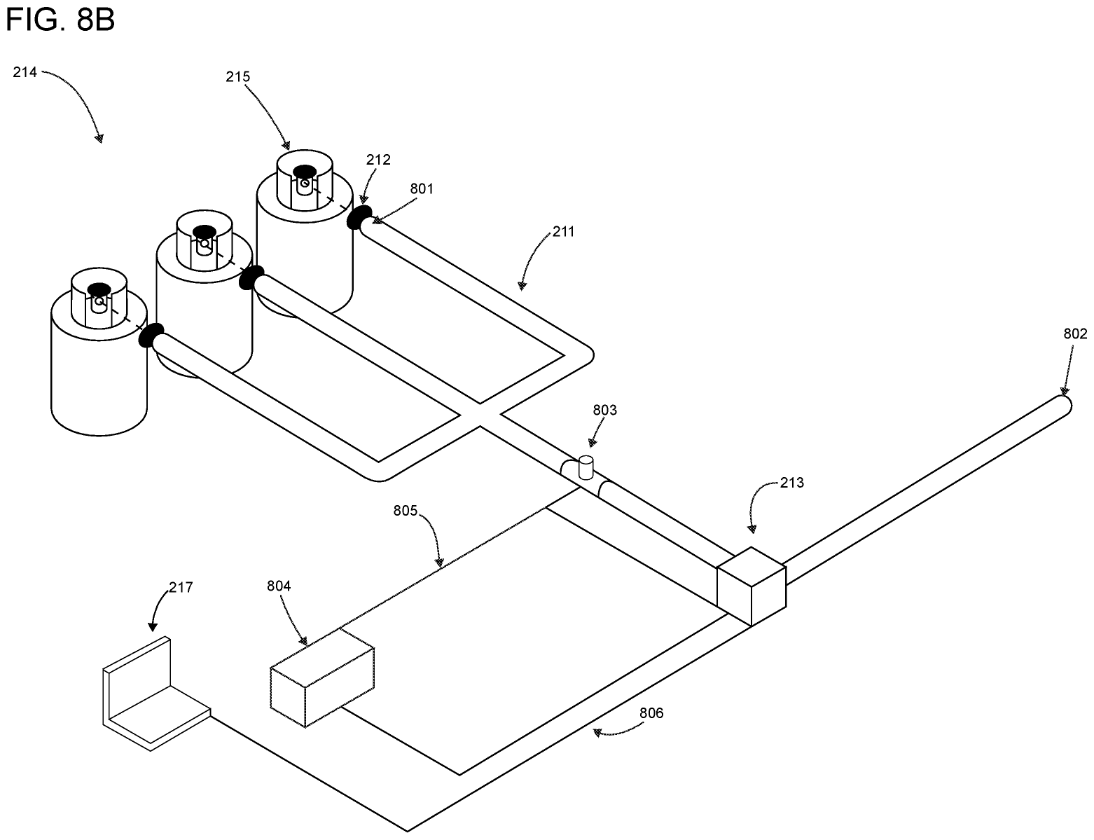

Now referring to FIG. 8A-B, a detailed diagram of gas distribution manifold. Gas distribution manifold 214 consists of gas supply line 211, gas regulator 212, gas safety switch 213, and gas storage tanks 215, manifold inlet connector 801, manifold outlet connectors 802, safety switch valve 803, valve power supply 804, and power supply wire 805.

Gas storage tanks 215 contain flammable gas like propane (LPG). Depending on the size of the cylindrical tank 203, it may be required to have more than one gas storage tank 215 to provide enough volume of flammable gas 221 in order to sustain flame 222. In scenarios where multiple gas storage tanks 215 are required, each tank has a dedicated gas regulator 212. In order to combine the flammable gas 221 from multiple gas storage tanks 215, a distribution manifold 214 is required and each gas storage tank 215 has a dedicated manifold inlet connector 801.

In scenarios where gas supply line 211 is portable and require the gas supply line 211 to be removed, it is possible that plumbing with the required size to support the volume of flammable gas 221 required to sustain flame 222 is not available. In this scenario multiple manifold outlet connectors 802 are required to supply cylindrical tank 203 with enough flammable gas 221.

For each manifold outlet connector 802, a flammable gas-rated solenoid gas safety switch valve 803 is added inline and connected to a switch to provide an easy way to turn on and off the supply of flammable gas 221.

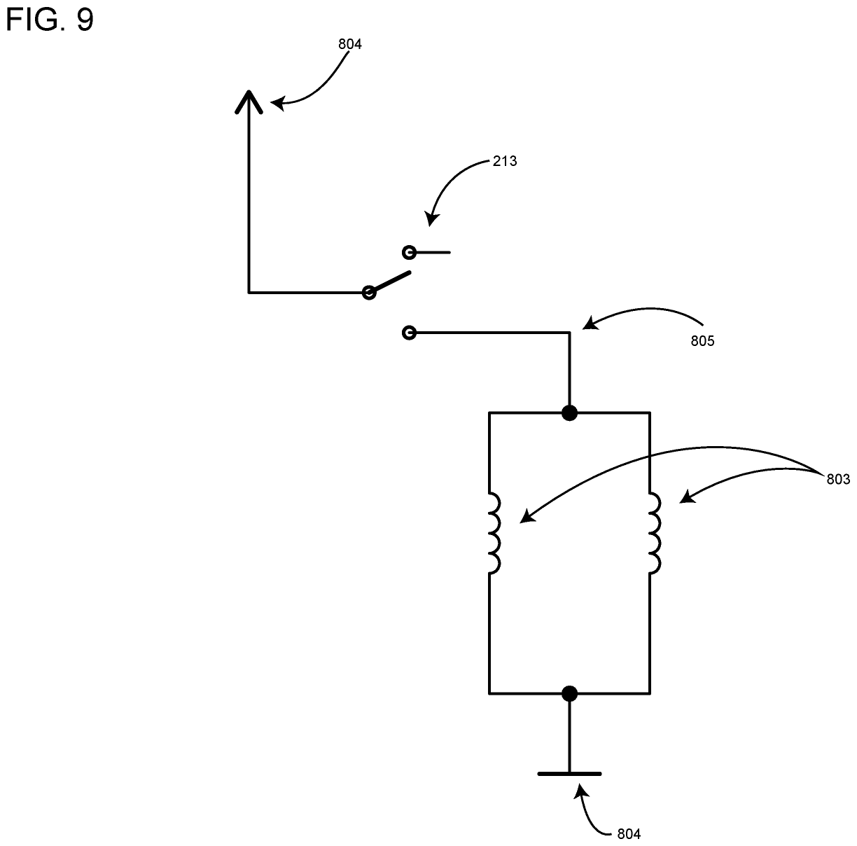

Gas safety switch 213 is connected to each gas safety switch valve 803 using power supply wire 805. Depending on the specifications of the relay, AC or DC power can be provided to the gas safety switch 213 and gas safety switch valve 803 by valve power supply 804. Based on those specifications the correct sized copper wire can be used to provide power to the gas safety switch valve 803. A sample schematic of this circuit is represented by FIG. 9.

In another embodiment, referring to FIG. 8B, gas safety switch 213 could be replaced with a computer-controlled relay like the Beefcake Relay Control Kit product by SparkFun Electronics®. Gas safety switch 213 is also connected to computer-based control 217 through control wire 806.

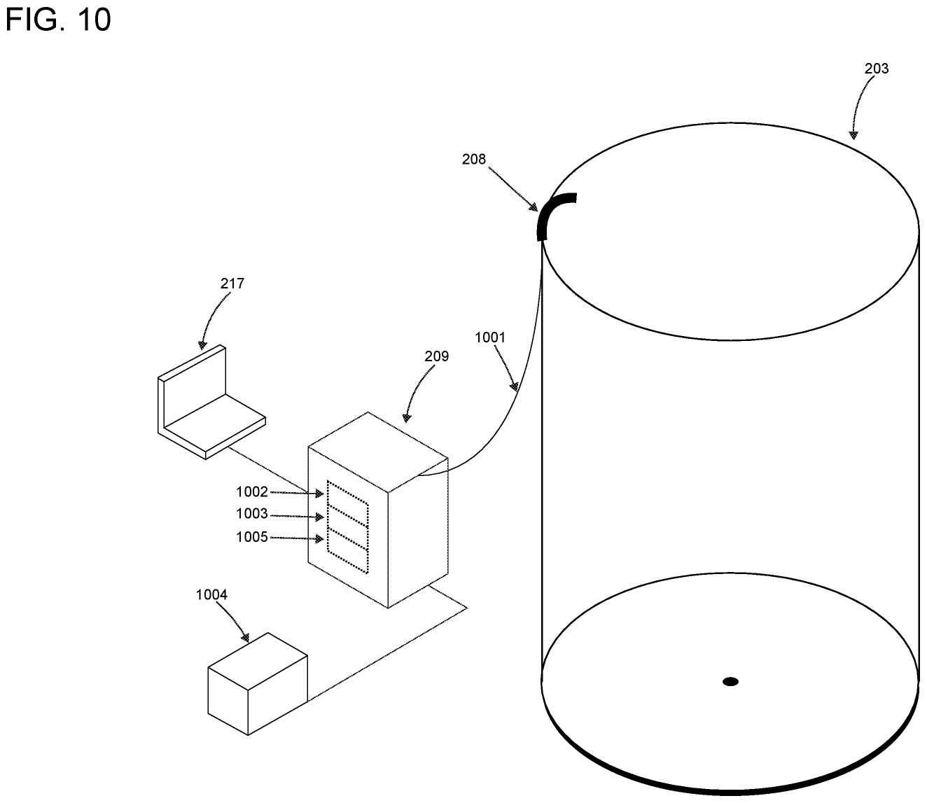

Now referring to FIG. 10, a diagram of the ignition system as attached to cylindrical tank 203. The ignition system consists of igniter 208, ignition control circuitry 209, computer-based control 217, wiring 1001, microcontroller 1002, inductor 1003, power source 1004, relay 1005, and optionally infrared detector 1006.

Igniter 208 generates a high voltage electrical arc, sometimes referred to as a spark-gap igniter, that is capable of igniting flammable gas 221, turning it into flame 222. The high voltage is created by inductor 1003 that takes a lower voltage and steps it up to a higher voltage and sends it over wiring 1001 to igniter 208. For example, a lower voltage of 3.3 VDC can be supplied to the inductor 1003 and inductor 1003 steps it up to 250,000+VDC.

Ignition control circuitry 209 consists of a microcontroller 1002, power source 1004, relay 1005, and an interface to computer-based control 217. Microcontroller 1002 is a computer device that consists of a microprocessor, flash memory, volatile memory, and interface pins which are commonly referred to as GPIO pins. Products that serve this purpose are like the Arduino® Uno by Arduino AG. Stored in microcontroller 1002 memory is a software program that controls the ignition control circuitry 209. Interfacing into microcontroller 1002 is a computer-based control 217. Computer-based control 217 can communicate with microcontroller 1002 using protocols like the DMX512 standard developed by the Engineering Commission of the United States Institute for Theatre Technology (USITT). The job of the computer-based control 217 is to provide an interface into the ignition control circuitry 209 for a user to turn the igniter 208 on and off. In some embodiments this can be done over a remote connection.

In another embodiment, the computer-based control 217 and the ignition control circuitry 209 can be combined and a single device can perform both functions of giving the user the ability to turn igniter 208 on and off. This can be done with products like the Raspberry Pi 3 Model B+ by the Raspberry Pi Foundation.

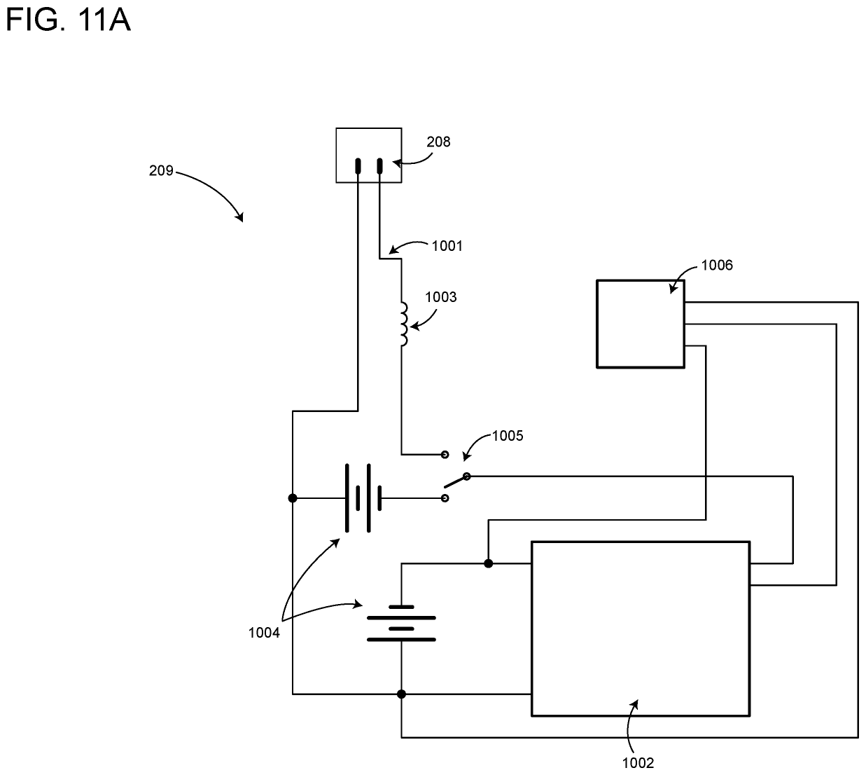

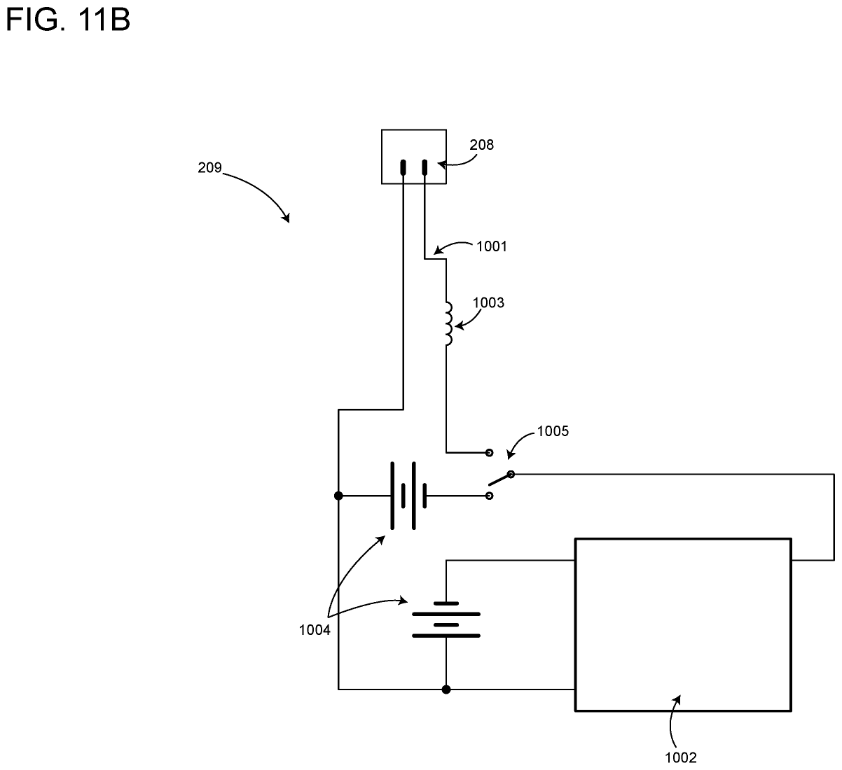

In another embodiment, it is possible to add circuitry to automatically detect if flame 222 has gone out and to trigger software on microcontroller 1002 to re-ignite flame 222. This can be done using infrared detector 1006 attached to igniter 208. An electrical schematic of this is shown in FIG. 11A.

Ignition control circuitry 209 connects to relay 1005, which, when the relay is closed, completes the connection with power source 1004 and relay 205 through wire 1001. Power source 1004 can be an AC to DC power supply, battery like a lithium-ion polymer (LiPo), or capacitor. An electrical schematic of this is shown in FIG. 11B.

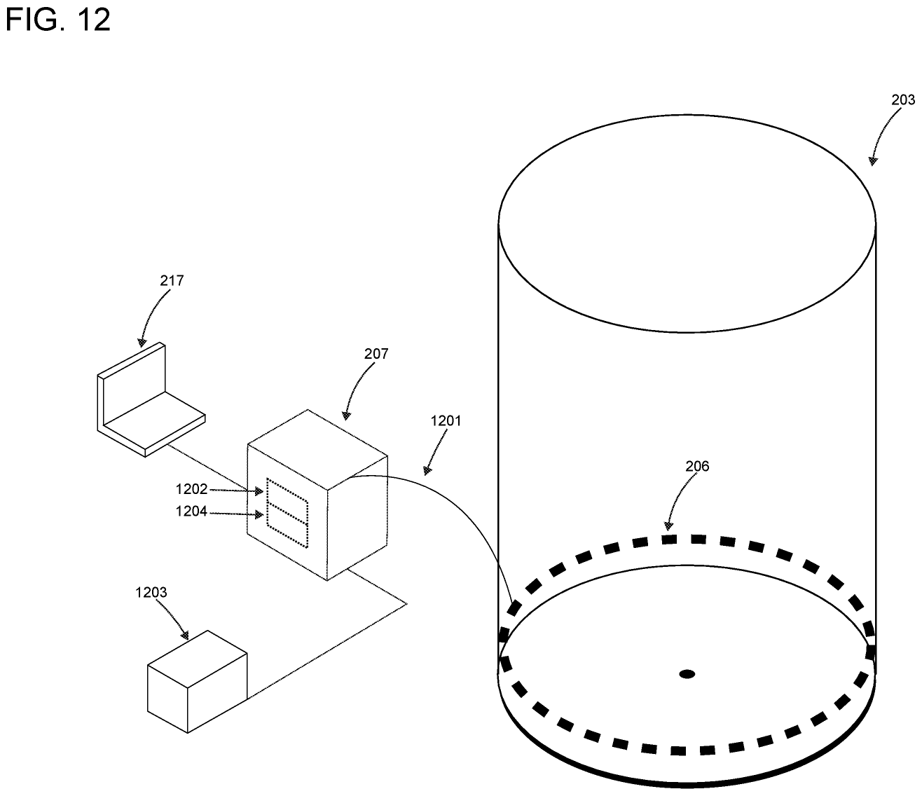

Now referring to FIG. 12, a diagram of the multi-color lighting system. The multi-color lighting system affixed to cylindrical tank 203 consists of multi-color lighting 206, lighting control circuitry 207, computer-based control 217, wiring 1201, microcontroller 1202, and power source 1203.

Multi-color lighting 206 consists of multiple red-green-blue (RGB) light-emitting diodes (LEDs) that are controllable by lighting control circuitry 207. The LEDs can be controlled by the wire 1201 supplying power or ground to each individual LED or RGB LED packages like the WS2812B. For the WS2812B LEDs, each LED can be controlled over a single-wire serial protocol.

In another embodiment, multi-color lighting 206 can be comprised of single LEDs in colors like red, green, and blue. These LEDs can be made in single electronic component packages, or as strips, and can include one or more colors. For this disclosure it is assuming that the LEDs are RGB single packages with a control interface similar to WS2812B.

Lighting control circuitry 207 consists of a microcontroller 1202, power source 1203, and an interface to computer-based control 217. Microcontroller 1202 is a computer device that consists of a microprocessor, flash memory, volatile memory, and interface pins which are commonly referred to as GPIO pins. Products that serve this purpose are like the Arduino® Uno by Arduino AG. Stored in microcontroller 1202 memory is a software program that controls the lighting control circuitry 207. Interfacing into microcontroller 1202 is a computer-based control 217. Computer-based control 217 can communicate with microcontroller 1202 using protocols like the DMX512 standard developed by the Engineering Commission of the United States Institute for Theatre Technology (USITT). The job of the computer-based control 217 is to provide an interface into the lighting control circuitry 207 for a user to turn on, off, changing of colors, and brightness of multi-color lighting 206. In some embodiments this can be done over a remote connection.

In another embodiment, the computer-based control 217 and the lighting control circuitry 207 can be combined and a single device can perform both functions of giving the user the ability to turn on, off, changing of colors, and brightness of multi-color lighting 206. This can be done with products like the Raspberry Pi 3 Model B+ by the Raspberry Pi Foundation.

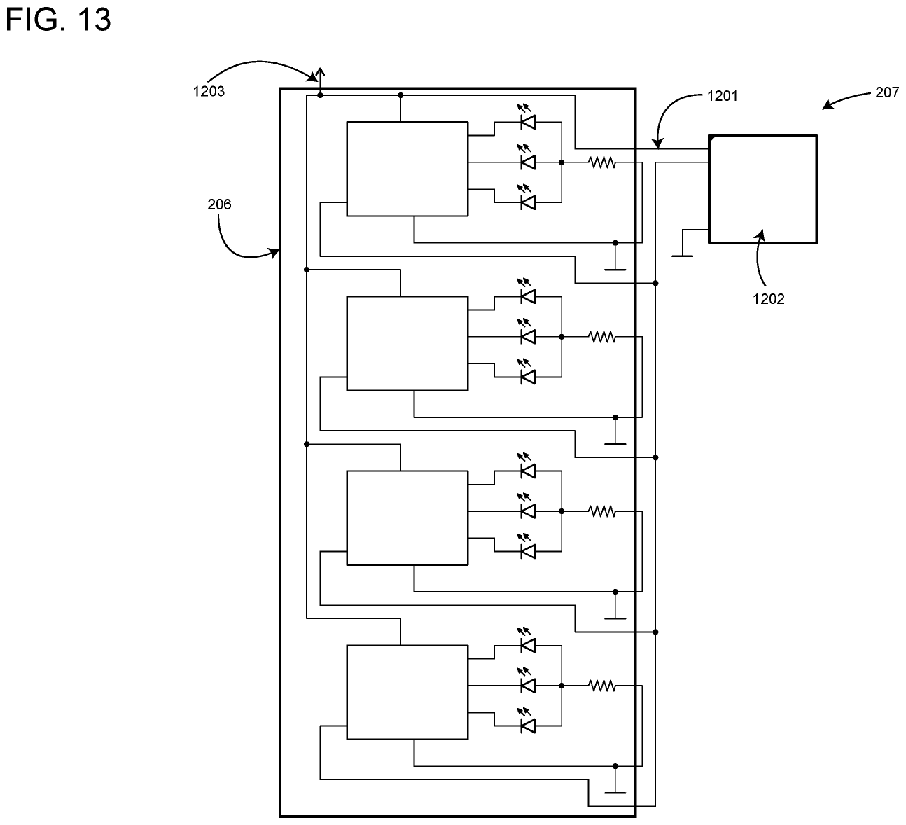

Lighting control circuitry 207 connects to multi-color lighting 206, which, when the software sends the data to each LED, changes the state of that LED through wire 1201. Power source 1203 can be an AC to DC power supply, battery like a lithium-ion polymer (LiPo), or capacitor. An electrical schematic of this is shown in FIG. 13.

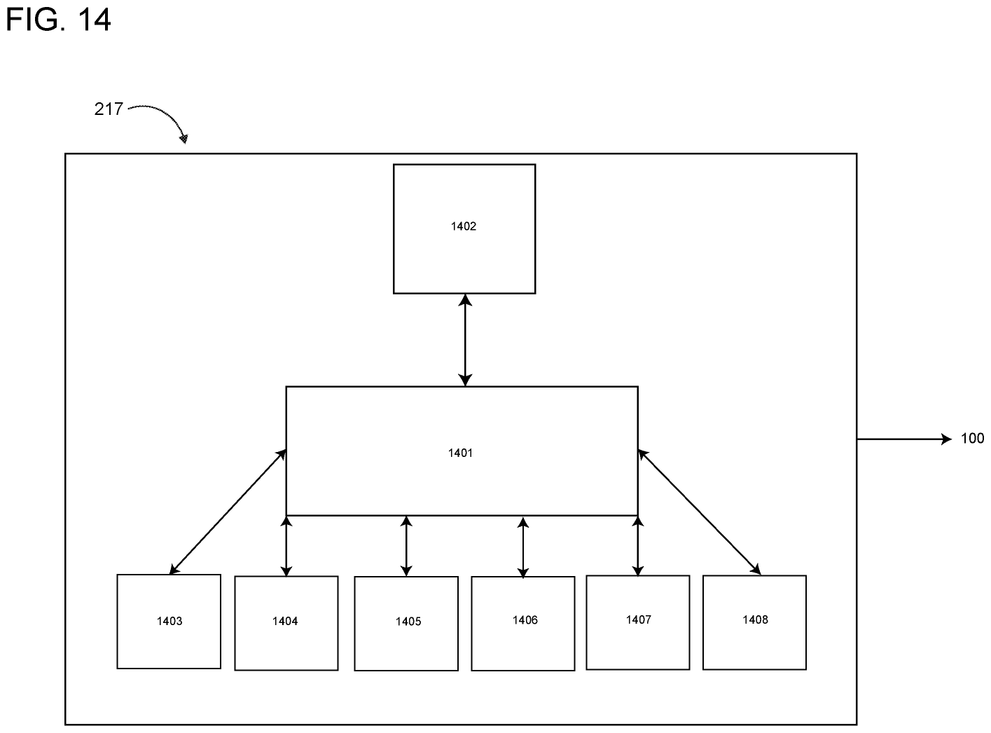

Now referring to FIG. 14, a diagram of the computer-based control system. The computer-based control 217 consists of a computer with a processing unit 1402, volatile memory 1403, non-volatile storage 1404, network interface 1405, input interface 1406, display interface 1407, control interface 1408, and bus 1401.

Processing unit 1402 is the component of the computer-based control 217 that is capable of executing machine readable instructions, through bus 1401, like reading from volatile memory 1403, non-volatile storage 1404, network interface 1405, input interface 1406, and control interface 1408 and writing to volatile memory 1403, non-volatile storage 1404, network interface 1405, display interface 1407, and control interface 1408.

Bus 1401 is connected to processing unit 1402, volatile memory 1403, non-volatile storage 1404, network interface 1405, input interface 1406, display interface 1407, and control interface 1408 to provide connectivity for all components of the computer system to communicate.

Volatile memory 1403 is used by the processing unit 1402 to store temporary information in a higher speed, lower latency, storage medium. Non-volatile storage 1404 is used to store information permanently on a storage medium that can withstand power loss to the computer system. Network interface 1405 is used for communicating with external computer systems and devices. For example, network interface 1405 can support protocols like IPv4, IPv6, Wi-Fi, and WiMax. Input interface 1406 is used to capture input from the user and, for example, can be in the form of a keyboard or optical mouse. Display interface 1407 is used to display information to the user and, for example, can be a textual based display, graphical based display on devices like cathode-ray tube and liquid crystal display monitors. Control interface 1408 is the interface that is used to communicate with the visual water feature system 100 and, for example, can be the DMX512 standard developed by the Engineering Commission of the United States Institute for Theatre Technology (USITT).

Running on the computer-based control system is software that enables the user to provide input, process the input, and communicate the user's commands to be executed by the visual water feature 100. Computer-based control 217 can be connected to lighting control circuitry 207, and ignition control circuitry 209. Software running on computer-based control 217 takes the input from the user and converts it into a command set like the DMX512 standard to communicate with the lighting control circuitry 207 and ignition control circuitry 209.

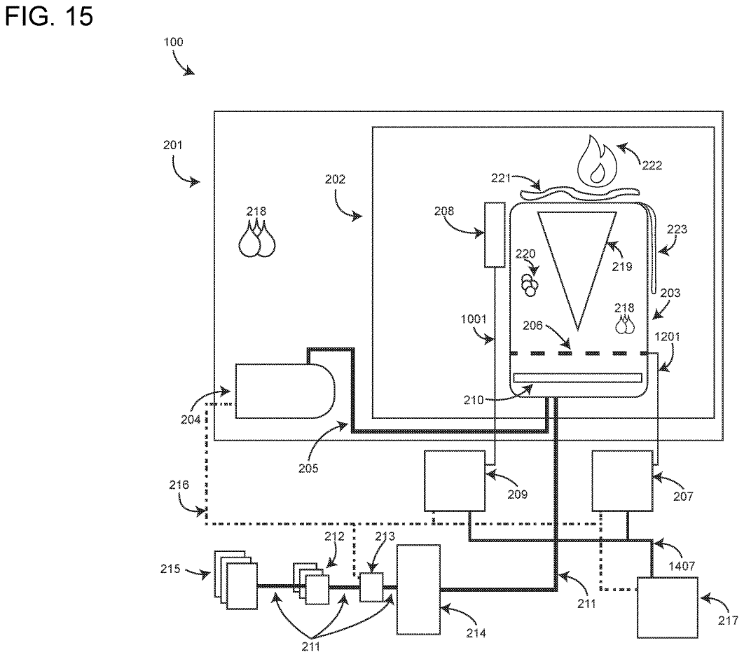

Now referring to FIG. 15, a block diagram of the entire system. Visual water feature 100 shows all of the components including basin 201, stand 202, cylindrical tank 203, liquid pump 204, plumbing 205, multi-color lighting 206, lighting control circuitry 207, igniter 208, ignition control circuitry 209, gas manifold 210, gas supply line 211, gas regulators 212, gas safety switch 213, gas distribution manifold 214, gas storage tanks 215, electrical power 216, computer-based control 217, liquid water 218, vortex 219, gas bubbles 220, flammable gas 221, flame 222, and liquid water cascade 223.

Basin 201 contains liquid water 218, pump 204, plumbing 205, and stand 202. Placed on top of stand 202 is cylindrical tank 203. Connected to cylindrical tank 203 is igniter 208, multi-color lighting 206, and wire 1001 and 1201. Inside of cylindrical tank 203 is gas manifold 210, liquid water 218, vortex 219, and gas bubbles 220. On the surface of liquid water 218 inside of cylindrical tank 203 is flammable gas 221 and flame 222. Also, from the surface of liquid water 218 on top of cylindrical tank 203 is water cascade 223. Pump 204 circulates liquid water 218 through plumbing 205 that is connected to both pump 204 and cylindrical tank 203.

Gas supply line 211 is connected to gas manifold 210 through cylindrical tank 203 and to gas distribution manifold 214. Gas distribution manifold 214 is connected to gas safety switch 213 through gas supply line 211. Gas safety switch 213 is connected to gas regulators 212 through gas supply line 211. Gas regulators 212 are connected to gas storage tanks 215 through gas supply line 211.

Multi-color lighting 206 affixed to cylindrical tank 203 is connected through wire 1201 to lighting control circuitry 207. Igniter 208 affixed to cylindrical tank 203 is connected through wire 1001 to ignition control circuitry 209. Ignition control circuitry 209 and lighting control circuitry 207 is connected to computer-based control 217 through control interface 1408.

Electrical power 216 is connected to pump 204 inside of basin 201, lighting control circuitry 207, ignition control circuitry 209, gas safety switch 213, and computer-based control 217.

1. A visual water feature comprising of a basin that has a solid bottom, solid walls, and open top; a cylindrical tank that has a solid bottom, open top, and holds liquid water; a stand that supports the cylindrical tank mounted inside the basin.

2. The visual water feature of claim 1, further comprising of a basin that contains liquid water, plumbing, and pump to circulate liquid water from a basin through plumbing to the cylindrical tank.

3. The cylindrical tank of claim 1, further comprising of angled hardware that contains a water input inside the bottom of the cylindrical tank causing the liquid water to move in a circular direction around the cylindrical tank; contains a gas input inside the bottom of the cylindrical tank that is connected to a gas manifold, running around the entire inside of the cylindrical tank.

4. The cylindrical tank of claim 1, further comprising of an angled water input inside the bottom side wall of the cylindrical tank that causes the liquid water to move in a circular direction around the cylindrical tank.

5. The cylindrical tank of claim 1, further comprising of an angled gas input inside the bottom side wall of the cylindrical tank that is connected to a gas manifold, running around the entire inside of the cylindrical tank.

6. The gas manifold of claim 3, further comprising of the gas manifold affixed to the bottom of the cylindrical tank; the gas manifold affixed to the bottom side wall of the cylindrical tank.

7. The gas manifold of claim 3, further comprising of a plurality of gas nozzles in the gas manifold capable of producing bubbles when a pressurized supply of gas is provided to the gas manifold.

8. The cylindrical tank of claim 1, further comprising of a hole in the center bottom of the cylindrical tank capable of creating a liquid water vortex from the circular movement of liquid water.

9. The cylindrical tank of claim 1, further comprising of cascading water over the top of the cylindrical tank caused by the volume of water entering the cylindrical tank through the water input being greater than the water leaving the cylindrical tank through the vortex hole in the bottom of the cylindrical tank.

10. The cylindrical tank of claim 1, further comprising of a plurality of multi-color lighting affixed to the inside or outside of the cylindrical tank; connected to an individual light control circuit; having a power supply provide DC power to the at least one multi-color light; having a communication mechanism with a computer-based control system.

11. The bubbles of claim 7, further comprising of bubbles that are created from a flammable gas injected into the liquid water; converted to flame when gas bubbles are ignited on surface of liquid water.

12. A method for injecting gas into liquid water within a cylindrical tank, the method comprising of bubbles created from the manifold being comprised of a flammable gas; gas being delivered to manifold through at least one gas supply line; at least one gas line being combined to provide sufficient volume of flammable gas.

13. The method of claim 12, further comprising of the at least one gas storage tank and one gas regulator for the at least one gas storage tank.

14. The method of claim 12, further comprising of the at least one gas regulator being combined by a gas distribution manifold to supply the at least one gas line.

15. The method of claim 12, further comprising of the at least one gas safety relay for the at least one gas supply line.

16. A method for igniting gas in liquid water on top of a cylindrical tank, the method comprising of at least one high voltage electrical arc mounted to the top of a cylindrical tank; power supply to provide DC power to the at least one high voltage generating inductor; relay to turn power supply on and off, and control circuit to turn the relay on and off.

17. The control circuit of claim 16, further comprising of a communication mechanism with a computer-based control system.

18. The method of claim 16, further comprising of an infrared based flame detection circuit and a communication mechanism with a computer-based control system.

19. The visual water feature of claim 1, further comprising of an electrical system that provides alternating and/or direct current power to liquid water pump; at least one multi-color lighting; gas safety switch; igniter; ignition control system; lighting control system; and computer-based control system.

20. The visual water feature of claim 1, further comprising of a computer-based control method that provides communication with at least one ignition control circuit; provides communication with at least one lighting control circuit; provides control with at least one gas safety switch; contains the at least one input device capable of supporting user commands communicated to the at least one control circuit.
